(19) United States
(12) Patent Application Publication
(10) Pub. No.: US 2024/0351658 A1
(43) Pub. Date: Oct. 24, 2024

(54) METHOD FOR DETECTING A CHANGE OF DIRECTION OF A SINGLE-TRACK VEHICLE

(71) Applicant: Robert Bosch GmbH, Stuttgart (DE)

(72) Inventor: Matthias Moerbe, llsfeld-Helfenberg (DE)

(21) Appl. No.: 18/686,380

(22) PCT Filed: Sep. 21, 2022
(86) PCT No.: PCT/EP2022/076229

§ 371 Date: Feb. 23, 2024

(30) Foreign Application Priority Data
Nov. 3, 2021 (DE) 10 2021 212 360.0

(51) Int. Cl. B62J 50/25; B62J 6/26; B62J 45/415

(52) U.S. Cl. CPC B62J 50/25; B62J 6/26; B62J 45/415

(57) ABSTRACT

A method for detecting a change of direction of a single-track vehicle and transmitting information to another vehicle. In the method, the steering torque in the single-track vehicle is ascertained and a change of direction is detected if the steering torque and/or the change in the steering torque exceeds an assigned limit value, whereupon, if a change of direction is detected, a warning signal is transmitted to another vehicle the travel lane of which is intersected by the travel trajectory of the single-track vehicle.

### FIELD

The present invention relates to a method for detecting a change of direction of a single-track vehicle and for transmitting information to another vehicle.

### BACKGROUND INFORMATION

Motor vehicles with autonomously braking systems that carry out an automatic braking intervention as a function of the driving situation are conventional. European Patent No. EP 2 404 195 B1, for example, describes a method for detecting an overtaking or evasive maneuver of a motor vehicle, in which the travel trajectory is precalculated on the basis of yaw angle, yaw acceleration, steering angle and wheel speeds and an automatic intervention in a driver assistance system is carried out.

Determining the relative movement of a motor vehicle to a detected collision object and specifying an evasive action is described in German Patent Application No. DE 10 2010 006 215 A1.

For motorized two-wheelers, carrying out autonomous braking in the event of a detected risk of collision via an emergency braking assistant without rider intervention is described in U.S. Patent Application Publication No. US 2017/0028971 A1.

### SUMMARY

A method according to the present invention relates to single-track vehicles, in particular motorized single-track vehicles such as motorcycles or scooters. The method makes it possible to automatically detect a change of direction of the single-track vehicle and, if necessary, transmit the change of direction as information to another vehicle for which there is a risk of a collision with the single-track vehicle. The change of direction of the single-track vehicle preferably consists of movements that lead to the single-track vehicle leaving its own lane.

According to an example embodiment of the present invention, the method takes place in two successive steps. In a first step, the current steering torque in the single-track vehicle, which is used as the basis for detecting a change of direction, is ascertained. Such a change of direction exists if the progression of the steering torque and/or the change in the steering torque exceeds an assigned limit value.

In a second, subsequent step, if a change of direction is detected, a warning signal is transmitted to another vehicle the travel lane of which is intersected by the travel trajectory of the single-track vehicle.

On the one hand, using the steering torque as a basis for detecting the change of direction has the advantage that the intended change of direction can be detected early and, on the other hand, serves with a high degree of reliability as a distinguishing feature for a change of direction of single-track vehicles. The initiation of a steering impulse can be identified via the steering torque or the change in the steering torque even before the vehicle has changed its direction of travel. Evaluating the steering torque, which is ascertained in the single-track vehicle by means of sensors, accordingly makes it possible to detect the change of direction earlier than when evaluating the steering angle. The steering torque can be ascertained via a steering torque sensor system in the single-track vehicle.

According to an example embodiment of the present invention, comparing the steering torque or the change in the steering torque with an assigned limit value ensures that significant changes of direction that could lead to the vehicle leaving its own lane are detected. This allows a distinction to compensating movements of the single-track vehicle that are not associated with leaving the lane to be made.

If a change of direction is detected, according to an example embodiment of the present invention, a warning signal is transmitted from the single-track vehicle to another vehicle if the travel lane of the other vehicle is intersected by the travel trajectory of the single-track vehicle that results from the change of direction. In this case, there is a risk of collision between the other vehicle and the single-track vehicle which is being indicated by the warning signal in the other vehicle. It is then possible for the other vehicle to react on the basis of the warning signal to eliminate or at least reduce the risk of collision.

The method according to the present invention thus serves to improve the safety of both single-track vehicles and other vehicles in the vicinity of the single-track vehicle which are on a collision course with the single-track vehicle that is changing its direction of travel.

According to an example embodiment of the present invention, the warning signal can be transmitted directly from the single-track vehicle to the other vehicle as part of a vehicle-to-vehicle communication. An indirect transmission of the warning signal, which is first transmitted from the single-track vehicle to a central station and then from the central station to the other vehicle, is possible as well.

According to one advantageous embodiment of the present invention, the warning signal is transmitted only to other vehicles that are within a defined maximum distance from the single-track vehicle. This ensures that only those other vehicles that are potentially on a collision course with the single-track vehicle receive the warning signal. However, a transmission to other vehicles without a defined maximum distance to the single-track vehicle is also possible.

The warning signal can be displayed in the other vehicle. A variety of display options are possible; in particular an acoustic and/or visual display, optionally also a haptic display, for example by vibrating a component in the other vehicle with which the driver is in contact, for example the steering wheel. The warning signal gives the driver the opportunity to react appropriately, in particular reduce the speed of the other vehicle or, if necessary, carry out an evasive maneuver.

According to a further advantageous embodiment of the present invention, the warning signal is used in the other vehicle to set parameters and/or activate a driver assistance system. The driver assistance system in the other vehicle in particular influences the longitudinal dynamics and possibly the lateral dynamics in the other vehicle; the driver assistance system is a braking assistant for automatically activating the brake system, for example, for instance an emergency braking assistant. It is thus possible to use the warning signal for an automatic reaction of the other vehicle.

According to yet another advantageous embodiment of the present invention, the position and the speed of the single-track vehicle are also transmitted to the other vehicle in addition to the warning signal. Sometimes the direction of movement of the single-track vehicle is transmitted to the other vehicle as well. A variety of information that allows the relative position of the other vehicle to the single-track vehicle to be ascertained and supports the calculation of the risk of collision is thus available to the other vehicle. Together with the warning signal, the additional information can form a signal packet that is transmitted directly or indirectly from the single-track vehicle to the other vehicle.

The current steering torque in the single-track vehicle, which is ascertained via a steering torque sensor system, can be used as the basis for determining a steering impulse from which the change of direction is ascertained. An intended change of direction can be identified from the steering impulse even before the direction of travel of the single-track vehicle has changed.

According to yet another advantageous embodiment of the present invention, the warning signal is also displayed in the single-track vehicle itself. This procedure has the advantage that the rider of the single-track vehicle is also given a warning of a possible collision with the other vehicle and the rider can react to this by changing the speed or changing the direction of travel.

According to yet another advantageous embodiment of the present invention, the warning signal is used in the single-track vehicle to set parameters and/or activate a rider assistance system in the single-track vehicle. This makes it possible to automatically bring about a change in the riding state in the single-track vehicle, for example activate an emergency braking assistant.

The present invention also relates to a control device which comprises means that are configured to carry out the above-described method. The means include at least one memory unit, at least one computing unit, a control device input and a control device output. The control device in the single-track vehicle can be used to detect a change of direction of the single-track vehicle and, if necessary, generate a warning signal that is transmitted directly or indirectly to the other vehicle.

The present invention also relates to a combination of at least two control devices which each comprise the above-described means for carrying out the method, wherein a control device is located in the single-track vehicle and another control device is located in the other vehicle in which the received warning signal is processed.

The present invention further relates to a computer program product comprising a program code which is designed to execute the above-described method steps. The computer program product runs in the above-described control device or in the combination of at least two control devices.

The present invention also relates to a single-track vehicle that is equipped with a steering torque sensor for acquiring the steering torque and with a control device in which the computer program product or portions of the computer program product run.

Further advantages and expedient embodiments of the present invention can be found in disclosure herein.

### BRIEF DESCRIPTION OF THE DRAWINGS

FIG. 1 shows a side view of a motorcycle that is equipped with a control device in which a change of direction is detected on the basis of a steering torque signal, according to an example embodiment of the present invention.

FIG. 2 shows a plan view onto a motorcycle on a road that wants to turn left and onto an oncoming other vehicle.

FIG. 3 shows a flowchart with method steps for detecting a change of direction and transmitting a warning signal to another vehicle, according to an example embodiment of the present invention.

### DETAILED DESCRIPTION OF EXAMPLE EMBODIMENT

FIG. 1 schematically shows a single-track vehicle embodied as a motorcycle 1. The motorcycle 1 is provided with a hydraulic brake system 2, which includes a front brake unit 3 on the front wheel, a rear brake unit 4 on the rear wheel as well as a brake control device and a hydraulic pump for setting the hydraulic brake pressure. A braking assistant can be implemented in the brake control device as a rider assistance system, with which an autonomous braking intervention can be carried out independently of the rider.

The motorcycle 1 is equipped in the usual manner with a drive motor. The motorcycle 1 is further provided with a control device 5, in which sensor signals from a sensor system comprising a steering torque sensor 6, a surroundings sensor 7 and an inertial sensor 8 are processed. The steering torque sensor 6 provides the steering torque that the rider is applying to the steering handle. The surroundings sensor 7 can acquire the surroundings of the motorcycle 1, in particular in the area in front and to the side of the motorcycle. The surroundings are acquired either optically using a camera or using radar beams.

Riding state variables of the motorcycle 1 can be acquired via the inertial sensor 8; these include the vehicle speed, the longitudinal and the lateral acceleration as well as the rotation rates about the longitudinal axis of the vehicle, the transverse axis of the vehicle and the vertical axis of the vehicle.

The motorcycle 1 can optionally also be equipped with wheel speed sensors for acquiring the wheel speeds of the front wheel and the rear wheel.

A rider-initiated change of direction can be detected based on the steering torque ascertained in the steering torque sensor 6. In the event that a change of direction associated with a lane change is initiated, for example when turning, a warning signal that is transmitted to another vehicle in the vicinity of the motorcycle 1 is generated in the motorcycle 1.

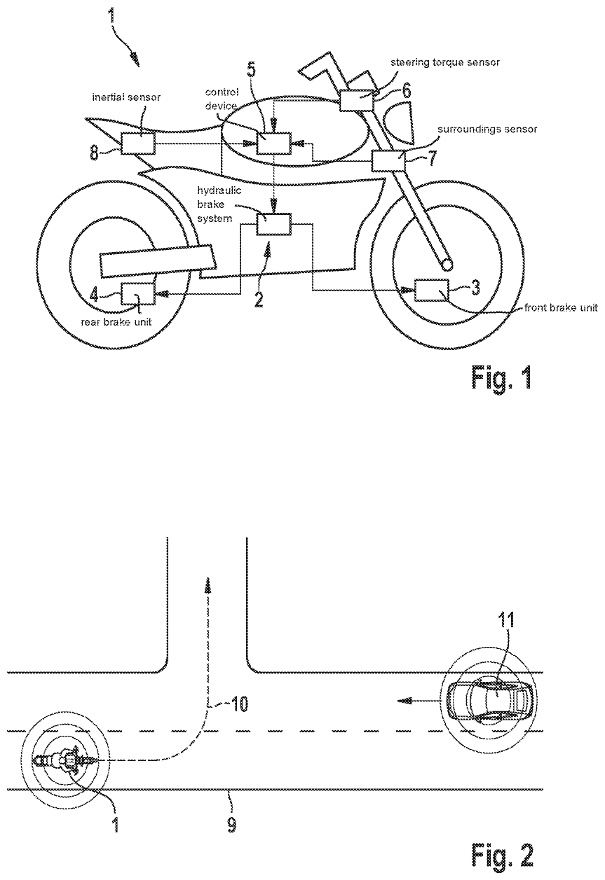

This situation is shown in FIG. 2. The motorcycle 1 is traveling as is proper in the right lane of the road 9 and the rider intends to change direction along the trajectory 10 in order to turn left. The rider's desire to turn can be detected based on the steering torque, which is currently being generated and applied to the handlebars by the rider and acquired via the steering torque sensor, and/or the change in the steering torque ascertained from the progression of the steering torque.

Another vehicle in the form of a motor vehicle 11 is approaching the motorcycle 1 in the oncoming traffic lane of the road 9. Based on the current distance and the relative speed between the motorcycle 1 and the other vehicle 11, an impending risk of collision can be identified in the control device of the motorcycle 1, whereupon a warning signal which is transmitted from the motorcycle 1 to the other vehicle 11 is generated in the control device. The transmission takes place either directly from the motorcycle 1 to the other vehicle 11 by means of vehicle-to-vehicle communication or indirectly from the motorcycle 1 to a central station and from the central station on to the other vehicle 11. The transmission of the warning signal is shown in FIG. 2 with concentric circles around the motorcycle 1 (emitted warning signal) and around the other vehicle 11 (received warning signal).

The received warning signal can be further processed in the other vehicle 11. The warning signal can be displayed in the other vehicle 11, in particular acoustically or optically. Processing of the warning signal in a driver assistance system of the other vehicle 11 in order to automatically influence the driving state of the other vehicle and eliminate or at least reduce the risk of a collision with the motorcycle 1 is possible as well.

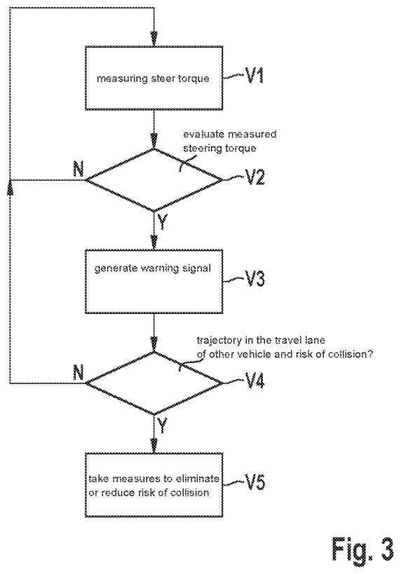

FIG. 3 shows a flowchart with method steps for detecting a change of direction and transmitting a warning signal to another vehicle in the event of an impending collision. In the first method step V1, the steering torque in the motorcycle is measured continuously by means of the steering torque sensor. In the next method step V2, the measured steering torque is evaluated with respect to a change of direction initiated by the rider. Such a change of direction exists if the steering torque exceeds a limit value. Alternatively, it is also possible to consider the change in the steering torque, in which case a change of direction exists if the change in the steering torque exceeds an assigned limit value. Where appropriate, a combination of the two criteria relating to the steering torque and the change in the steering torque is carried out.

A change of direction is understood to be the application of a steering impulse that is large enough to steer the motorcycle out of its lane. Smaller steering corrections that do not lead to steering out of the lane, on the other hand, are irrelevant.

If the evaluation in method step V2 shows that the conditions for a change of direction are not met, the system follows the no branch (“N”) and returns to method step V1 which is repeated at cyclical intervals.

If, on the other hand, the query in method step V2 shows that the conditions for a change of direction are met, the system advances to the next method step V3 following the yes branch (“Y”). In method step V3, a warning signal is generated in the motorcycle and transmitted into the surroundings. Other vehicles inside the transmission radius of the warning signal emitted by the motorcycle can receive and evaluate the warning signal.

Advantageously, the position and the speed of the motorcycle are also emitted in addition to the warning signal in a signal packet and transmitted to other vehicles in the vicinity. The direction of movement of the motorcycle can furthermore be transmitted in the signal packet as well.

According to the next method step V4, the warning signal and the further information from the signal packet can be processed in a control device in the other vehicle. Based on the signal packet and taking into account the ego position, the speed and the direction of travel, it is possible to determine whether the trajectory of the motorcycle is in the travel lane of the other vehicle and there is a risk of collision between the other vehicle and the motorcycle. If this is not the case, the system can return to the beginning of the method in method step V1 following the no branch.

If, on the other hand, the evaluation in the other vehicle shows that there is a risk of collision, the system follows the yes branch and advances to the next method step V5, in which measures to eliminate or at least reduce the risk of collision are taken. These measures include the optical or acoustic display of the warning signal, for example, to which the driver can react to avoid the impending collision, for example by braking the other vehicle. In addition or as an alternative to displaying the warning signal, an automatic intervention in a driver assistance system in the other vehicle can be carried out as a measure; for instance an emergency braking system can be activated in order to automatically slow the other vehicle and thus avoid the risk of collision.

1-12. (canceled)

13. A method for detecting a change of direction of a single-track vehicle and transmitting information to another vehicle, comprising the following method steps:
ascertaining a steering torque in the single-track vehicle, wherein a change of direction is detected when the steering torque and/or a change in the steering torque exceeds an assigned limit value;
transmitting, based on a change of direction being detected, a warning signal to another vehicle, a travel lane of which is intersected by a travel trajectory of the single-track vehicle.

14. The method according to claim 13, where the warning signal is transmitted directly from the single-track vehicle to the other vehicle as part of a vehicle-to-vehicle communication.

15. The method according to claim 13, wherein the warning signal is transmitted from the single-track vehicle to a central station and from the central station on to the other vehicle.

16. The method according to claim 13, wherein the warning signal is displayed in the other vehicle.

17. The method according to claim 13, wherein the warning signal is used in the other vehicle to set or activate a driver assistance system.

18. The method according to claim 13, wherein a position and a speed of the single-track vehicle are also transmitted to the other vehicle in addition to the warning signal.

19. The method according to claim 13, wherein a steering impulse which is used as a basis for ascertaining the change of direction is ascertained from a current steering torque.

20. The method according to claim 13, wherein the warning signal is displayed in the single-track vehicle.

21. The method according to claim 13, wherein the warning signal is used in the single-track vehicle to set or activate a rider assistance system.

22. A control device or combination of control devices for detecting a change of direction of a single-track vehicle and transmitting information to another vehicle, the control device or combination of control devices configured to:
ascertain a steering torque in the single-track vehicle, wherein a change of direction is detected when the steering torque and/or a change in the steering torque exceeds an assigned limit value;
transmit, based on a change of direction being detected, a warning signal to another vehicle, a travel lane of which is intersected by a travel trajectory of the single-track vehicle.

23. A single-track vehicle, comprising:
a steering torque sensor configured to acquire the steering torque; and
a control device or combination of control devices for detecting a change of direction of a single-track vehicle and transmitting information to another vehicle, the control device or combination of control devices configured to:
ascertain, using the steering torque sensor, a steering torque in the single-track vehicle, wherein a change of direction is detected when the steering torque and/or a change in the steering torque exceeds an assigned limit value;
transmit, based on a change of direction being detected, a warning signal to another vehicle, a travel lane of which is intersected by a travel trajectory of the single-track vehicle.

24. A non-transitory computer-readable medium on which is stored a computer program including a program code for detecting a change of direction of a single-track vehicle and transmitting information to another vehicle, the program code, when executed by a control unit or combination of control units, causing the control unit or combination of control units to perform the following method steps:
ascertaining a steering torque in the single-track vehicle, wherein a change of direction is detected when the steering torque and/or a change in the steering torque exceeds an assigned limit value;
transmitting, based on a change of direction being detected, a warning signal to another vehicle, a travel lane of which is intersected by a travel trajectory of the single-track vehicle.
